(19) United States
(12) Patent Application Publication
(10) Pub. No.: US 2001/0018672 A1
(43) Pub. Date: Aug. 30, 2001

(54) Method and apparatus for facilitating the sale of goods over the internet

(75) Inventors: Thomas J. Petters, Edina, MN (US); Brad W. Dennis, Fridley, MN (US); Thomas Hay, North Oaks, MN (US); Theodore L. Stortz, Minneapolis, MN (US); Dove Carter, Eden Prairie, MN (US)

Correspondence Address: SCHWEGMAN, LUNDBERG, WOESSNER & KLUTH, P.O. BOX 2938, MINNEAPOLIS, MN, 55402, US

(73) Assignee: redtagoutlet.com, inc.

(21) Appl. No.: 09/821,228

(22) Filed: Mar. 29, 2001

Related U.S. Application Data
(62) Division of application No. 09/475,401, filed on Dec. 30, 1999.

(51) Int. Cl. G06F 17/60

(52) U.S. Cl. 705/26; 705/27; 705/37

(57) ABSTRACT

Method and apparatus for the sale of goods over the Internet provides, in one example embodiment, a sales or “scrubbing” agent receiving a request to offer goods for sale on an Internet web site, with the request specifying the kind of goods, and restrictions on the sale of the goods. The scrubbing agent validates that the goods are as specified in the request, and offers the goods for sale over the Internet in accordance with any applicable restrictions. The scrubbing agent receives offers over the Internet to purchase the goods, and assures that that any sales of the goods will be made in accordance with any restrictions specified for the sale of the goods. Also, the scrubbing agent may arrange to ship any goods sold, and, optionally, arrange for or invoice the buyer of goods and arrange for or remit payment to the seller of the goods. According to one example embodiment, the seller and buyer of the goods remain anonymous to one another. According to another example embodiment, the scrubbing agent physically inspects the goods to verify that they are bona fide and in conformance with a proposed listing from a seller, before being posted for sale on the Internet.

### COPYRIGHT NOTICE/PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawing hereto: Copyright © 1999, Redtagoutlet.com, Inc. All Rights Reserved.

### TECHNICAL FIELD OF THE INVENTION

The present invention pertains generally to electronic systems for supporting sales transactions, and more particularly to an Internet-based system for the sale of goods over the Internet.

### BACKGROUND OF THE INVENTION

Online sales over the Internet have grown dramatically in just a few short years. Purchasing retail goods online, where the quality and quantity of the goods offered for sale is known with some degree of assurance, is of relatively low risk to a potential buyer. Purchasing other types of goods such as antiques, used goods, or large volumes of goods, can be much riskier when done over the Internet. While the risk for such transactions may be acceptable where the dollar value of the purchase is relatively low, for example less than a few hundred dollars, the risk of such transactions involving more substantial sums is great. Accordingly, there is a need for a system and process for the sale of goods over the Internet for such transactions.

### SUMMARY OF THE INVENTION

The present invention provides method and apparatus for the sale of goods over the Internet. According to one example embodiment, a sales or “scrubbing” agent receives a request to offer goods for sale on an Internet web site, with the request specifying the kind of goods, and restrictions on the sale of the goods. The scrubbing agent validates that the goods are as specified in the request, and offers the goods for sale over the Internet in accordance with any applicable restrictions. The scrubbing agent receives offers over the Internet to purchase the goods, and assures that that any sales of the goods will be made in accordance with any restrictions specified for the sale of the goods. Also, the scrubbing agent may arrange to ship any goods sold, and, optionally, arrange for or invoice the buyer of goods and arrange for or remit payment to the seller of the goods. According to one example embodiment, the seller and buyer of the goods remain anonymous to one another. According to another example embodiment, the scrubbing agent physically inspects the goods to verify that they are bona fide and in conformance with a listing from a seller, before the sale is completed.

These and various other embodiments of the invention are described below.

### BRIEF DESCRIPTION OF THE DRAWING

FIG. 1 illustrates one example embodiment of a system for the sale of goods using a scrubbing process according to the present invention.

FIGS. 2A, 2B and 2C illustrate a web site design according to one example embodiment of the invention.

FIG. 3 illustrates one example embodiment of a system for the sale of goods over the Internet according to the present invention.

FIGS. 4A, 4B, and 4C illustrate a data flow for one example embodiment of the invention.

FIG. 5 is an example embodiment of the Internet system according to the present invention.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

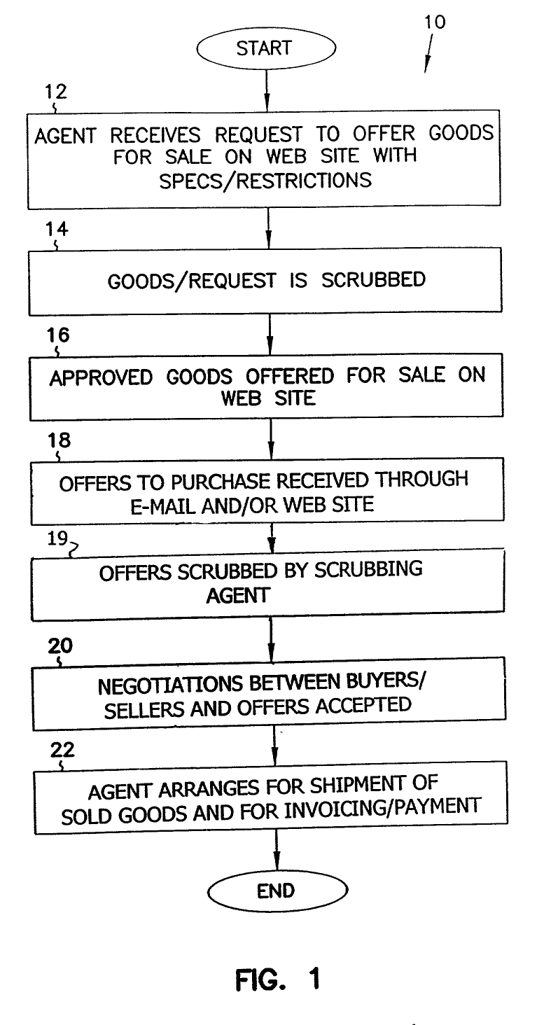

Referring now to FIG. 1, there is illustrated an overview of one embodiment of the process 10 of the present invention used to facilitate the sale of goods over the Internet or any comparable wide area network. Further, as used herein, the term “web site” shall mean a node on the Internet which is supported by a server generating web pages processed by a web browser or equivalent. As illustrated in FIG. 1, this process includes, among other elements, as illustrated by element 12, a “scrubbing agent,” sometimes referred to herein as the “scrubber,” receives a request to offer goods for sale on an Internet web site, wherein the request specifies the goods for sale, and any restrictions on the sale of the goods that the seller may wish to specify, as discussed more fully below. As used herein, the term “scrubbing agent” shall mean an agent which performs an electronic clearinghouse perfecting process, as defined more fully below. As further illustrated by element 14, process 10 further includes the agent “scrubbing” the goods proposed for sale by a seller, before such goods are placed on sale on the scrubbing agent's web site. Such goods include, without limitation, wholesale goods, bankruptcy goods, and going-out-of-business goods. This scrubbing process is described in more detail below. Next, the scrubbing agent offers the goods for sale on an Internet web site in accordance with any applicable restrictions such as that the goods may only be sold to a retailer, or only shipped to a designated geographic territory, as indicated in element 16. Offers for the purchase of the goods may then be received on the web site, as shown in element 18, and the offers are scrubbed by a scrubbing agent 19. Negotiations occur between buyers and sellers and an offer is accepted 20. The scrubbing agency then performs a number of tasks such as but not limited to physically inspecting the goods, arranging to ship the sold goods, and, if necessary, such that such shipping abides by any restrictions specified for the sale of the goods by the seller, as shown in element 22. In addition, the scrubbing agent may invoice the buyer of the goods and facilitate or make payment to the seller of the goods or make financing arrangements. These and other tasks performed by the scrubbing agent are described in more detail below.

According to one advantageous embodiment of the invention, scrubbing goods entails, at least in part, validating that the goods are of the kind, quality, condition, authenticity and/or quantity represented by the seller proposing to sell the goods over the agent's web site. On the other side of the transaction, the scrubbing agent investigates the buyer's credentials to establish the buyer meets one or more criteria established by the agent, such as the buyer's reputation in the business community or credit history. By this mechanism and others to be described hereinbelow, the scrubbing agent thus provides buyers and sellers an Internet marketplace wherein sales transactions may be accomplished by either buyers or sellers with confidence that goods offered for sale on the web site conform to the seller's representations and that a buyer of goods is credible and financially able to complete a sales transaction.

Thus, according to one example embodiment of the invention, the process and scrubbing agent's web site and computer system 28 is designed to provide the following operations and functions:

1) pre-approving and screening of buyers and sellers and assignment of a quality grade to each participant;

2) maintaining the confidentiality of buyers and sellers;

3) providing a trusted intermediary between buyers and sellers;

4) providing pricing and merchandising consultation;

5) verifying quantity, authenticity and condition of goods;

6) minimizing the risk for buyers and sellers;

7) facilitating transactions;

8) generating electronic purchase orders and invoices;

9) arranging credit terms; and

10) coordinating shipping, packing and delivery.

The invention, in one or more of the embodiments described herein, provides a seller can obtain the following advantages:

1) can remain anonymous;

2) can quickly post merchandise on the agent's web site;

3) can reach a worldwide network of pre-qualified buyers;

4) can deal with a single entity to carry out a transaction;

5) can maximize the selling price with minimum time and effort;

6) can project the total outcome of a sale online; and

7) can review account history online.

The invention, in one or more of the embodiments described herein, provides a buyer can obtain the following advantages:

1) can remain anonymous;

2) can reduce total acquisition cost;

3) can submit offers online;

4) can deal with a single entity to carry out a transaction;

5) can make payments electronically;

6) can qualify for credit;

7) can project a total estimate for transactions online; and

8) can review account history online.

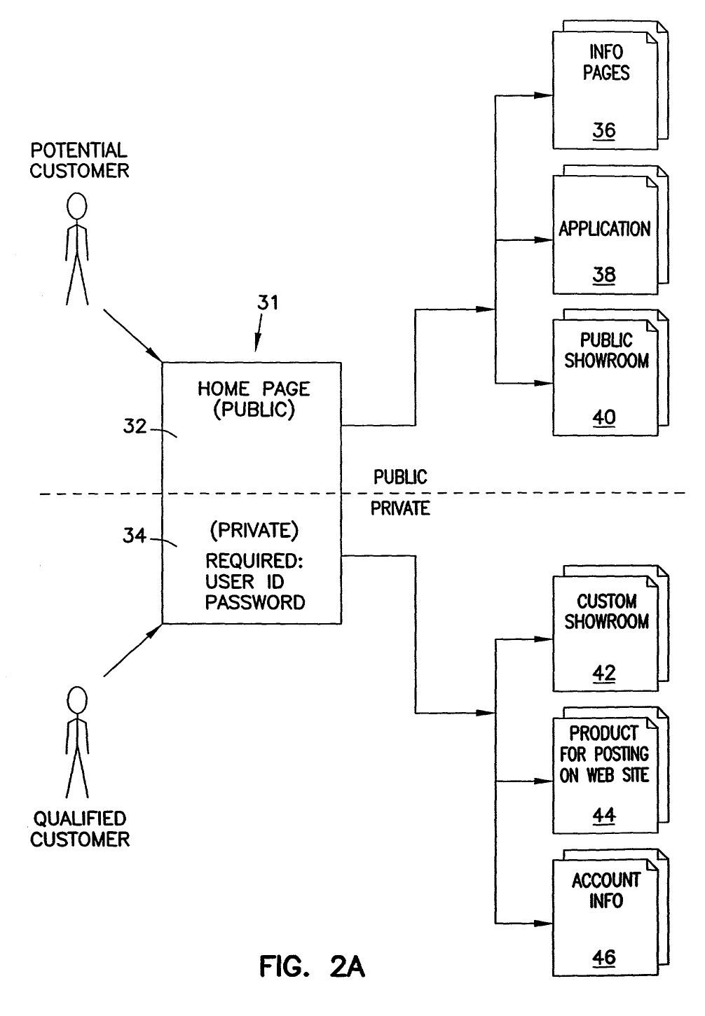

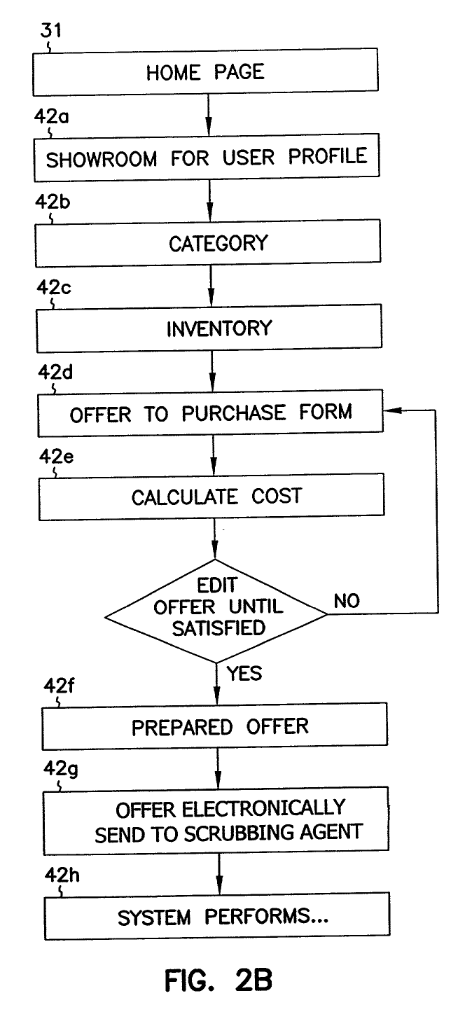

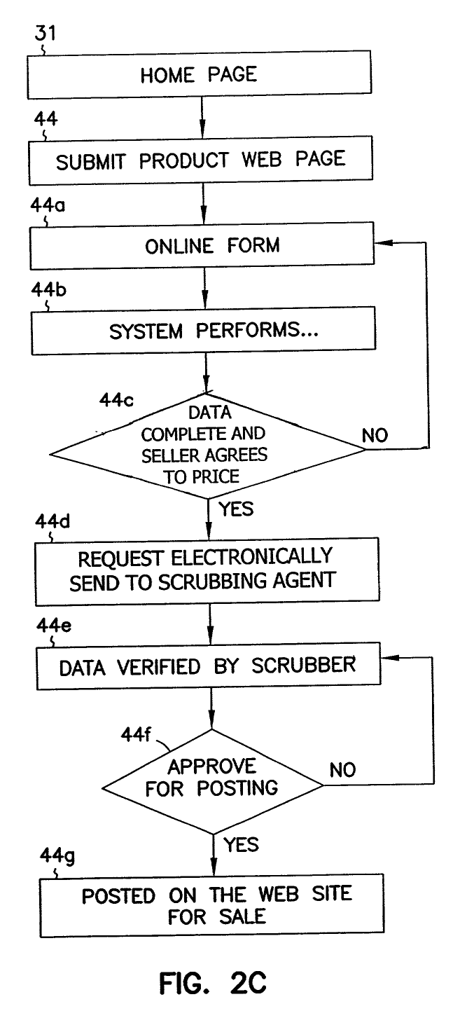

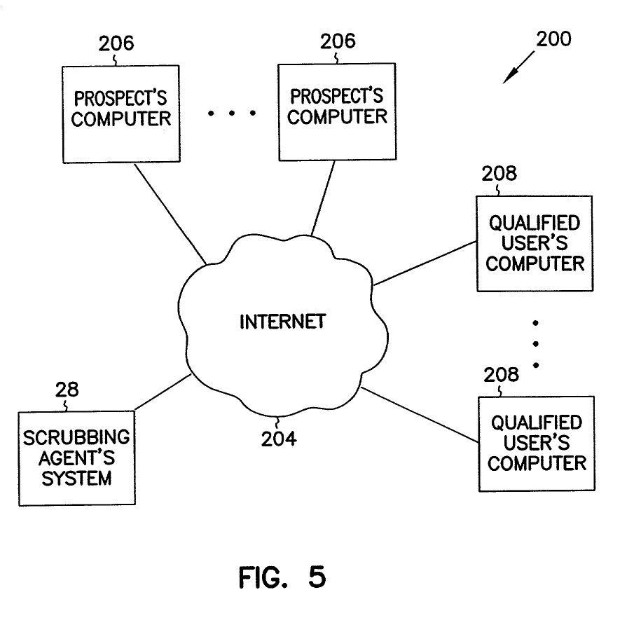

Referring now to FIGS. 2A, 2B and 2C, there is illustrated an overview of an architecture for an Internet-based system 28 supporting a web site 30, hosted on a computer system 28 connected to the Internet (as illustrated in FIG. 5 and described further below) according to one example embodiment of the invention. System 28 provides the necessary database and other software functionality to support the web site 30 and other functionality described herein. Web site 30 includes a home page 31 providing access to a public area 32 and a private area 34. The public area 32 provides potential customers or visitors one or more web pages generated to provide: 1) general information 36 about the web site, for example how to use the sales process using the web site; 2) an on-line application and contract documents 38 to collect application and contract data from potential customers; and 3) a showroom or listings of goods for sale 40 on the web site that have been designated “non-restricted inventories” currently available for sale on the web site. These web pages have all of the same functions of the qualified user showroom, described more fully below, without the functionality of making offers to purchase.

As further illustrated in FIG. 2B, application and contract documents pages 38 collect data for the scrubbing agent to process to determine if the user meets any standards applied by the agent to qualify a buyer or a seller. According to one example embodiment, there is provided an online contract that has an “accept” button or function that will enable the user to agree to and accept all of the terms and conditions specified within the contract. By accepting the contract online the application and contract can be submitted electronically to the agent for processing. If the application is approved, a hard copy of the contract is obtained from system 28 and sent to the qualified user for a hard copy signature. If the application data is incomplete or rejected, the applicant is informed by pages 38.

The private area 34 of the web site 30 is entered only by qualified users or customers that have a valid user ID and password. In one example embodiment, qualified users receive a user ID and password. There are three main areas contained within the qualified user portion of the web site, and users' access to those areas are determined to the privileges assigned to their user name and password. A qualified buyer can access web pages generated to provide a custom showroom 42 with listings of goods for sale. A qualified seller can access web pages generated to submit information on a product submission 44 for consideration by the scrubbing agent for posting for sale on the web site 30. Qualified buyers and sellers can access web pages generated to review their own user account information 46. In one example embodiment, a qualified seller is not permitted to view showroom postings of their own listings, thus precluding a seller from knowing the scrubbing agent's mark-up on the seller's goods.

According to one example embodiment and as illustrated further in FIG. 2C, the showroom 42 is customized to a user profile 42a to accommodate seller restrictions and/or buyer requested specifications (discussed above and further below). Showroom pages, provided by active server pages in one example embodiment, provide that users can enter the showroom and select a category 42b for viewing. Categories are defined, for example, as Electronics, Sporting Goods, Military Surplus, Tools or Miscellaneous. Each category lists available goods for sale, or in other words, inventories, that best fit that category. According to one example embodiment, inventories listed under a category heading contain the following information:

| Column Headings | Sample row detail: |
|---|---|
| Lot # | SG101 |
| Description | Callaway Biggest Big Bertha Drivers |
| # of SKU's | 8 |
| Total Quantity | 10,000 ea. |
| Total Price | $500,000.00 USD |
| Restrictions | non US Markets |
| Availability | Now |
| Location | US East Coast |
| Sell All Only. | Yes |
| End Date | 8-1-99 |

The showroom web pages further provide that by selecting one of the items 42c of inventories listed within a category, the user can review more detail related to the inventory. Inventories listed under an inventory heading will, according to one example embodiment of the invention, contain the following information in each row by SKU:

| Column Headings | Sample row detail: |
|---|---|
| SKU | CBB42R10 |
| Manf./Brand | Callaway |
| Description | Biggest Big Bertha Driver |
| Model # | MR42R10G |
| Size | 42″ Graphite Regular flex 10-degree Men's R |
| Color | Titanium |
| Weight/unit | 3 lbs. |
| Shipping Class | Al |
| # of units/Shipping Units | 1 |
| Weight/shipping unit | 3 lbs. |
| # of shipping units/pallet | 50 |
| Quantity | 500 |
| Unit Type | each |
| Unit Price | $50.00 |
| Extended Price | $25,000.00 |

In addition, in one example embodiment, each SKU row detail will have some type of “thumbnail” image attached to it as required.

The showroom pages further provide that, from the inventory detail list, the user is provided with an option to purchase form 42d. If this session is activated by a web page selection, all inventory detail and user information is transferred over to an online web offer to purchase form automatically. After performing any desired changes to the offer form as permitted, the web page user can select to calculate or re-calculate (on successive iterations) the projected total cost of the transaction 42e. Reiterations can be performed until the desired results are achieved.

Once an offer to purchase has been compiled to a satisfactory level, the user can then accept and place an offer 42f, which is then deemed submitted 42g to the agent. At this time the system 28 performs 42b the following:

1. Assign an offer number to the document.

2. Date and time stamp the offer.

3. Prompt the user to print a copy for their use, such as purchase order back up.

4. Electronically transmit the details to the scrubbing agent and update the system.

5. Launch an e-mail to the seller than an offer has been made with date & time.

6. Launch an e-mail to the buyer indicating that the offer has been received on the system (after the offer has been scrubbed).

7. Launch an e-mail to the scrubbing agent that an offer has been made on one of their accounts.

8. Update a database and start tracking the activity surrounding the offer.

Qualified users also submit product information 44a for review and approval by the scrubbing agent in order for such goods to be listed within the web site for sale as illustrated by pages 42 (FIG. 2A). Sellers must provide all required information. The web site 30 provides that information can either be keyed in online 44a, or uploaded from a variety of formats. This ensures that users are able to list product in the manner that best fits their needs.

According to one example embodiment, sellers are required to provide the following information:

(1 request per inventory listed by SKU)

| Descrip- | Attributes | | | |
|---|---|---|---|---|
| tion | by Qty | Terms | Location | Shipping Class |
| Quantity | Graphics | History | Posting | Units/shipping units |
| | | | end date | |
| Model # | Restrictions | Warranties | Ownership | Weight/shipping unit |
| | | | Title | |
| Price | Sell all or | Condition | Authen- | Shipping units/pallet |
| | portion | | ticity | |

Product lead times, is product available now or in production or other?

Once the information is received, the system 28 performs several tasks 44b including calculating the projected net selling price to be received by seller upon completion of the sale, based on the user's profile and other data as desired, and reiterates 44c the edit/calculate process until a desired result is obtained. Then, the requested is submitted 44d. Not all information provided to the scrubbing agent is necessarily used on the actual product listing when posted on the web site for sale. Not all inventories submitted will be posted on the web site for sale, as some inventories will be deemed unacceptable by the scrubbing agent. Thus, all inventories submitted will be verified or “scrubbed” 44e prior to posting. As noted above, one or more of the following criteria are applied in order to determine if the goods are acceptable for posting:

1) verification and perfection of seller's title in the goods;

2) physical inspection and verification of the quality, quantity and kind of the goods;

3) securing the transfer of the goods;

4) managing logistics of final deliveries;

5) verification buyer is financially capable of paying for purchased goods;

6) verifying location of the goods; and

7) verifying pricing of the goods.

Once an inventory has been deemed acceptable for posting 44f, the inventory is available to be posted 44g on the web site 30, in a showroom 42. The following information, according to one example embodiment, is used for posting the inventory goods for sale in a showroom 42:

| Column Headings | Sample row detail |
|---|---|
| Lot # | SG101 |
| Description | Callaway Biggest Big Bertha Drivers |
| # of SKUs | 8 |
| Total Quantity | 10,000 ea. |
| Total Price | $500,000.00 USD |
| Restrictions | non US Markets |
| Availability | Now |
| Location | US East Coast |
| Sell All Only. | Yes |
| End Date | 8-1-99 |
| SKU | CBB42R10 |
| Manf./Brand | Callaway |
| Description | Biggest Big Bertha Driver |
| Model # | MR42R10G |
| Size | 42″ Graphite Regular flex 10-degree Men's R |
| Color | Titanium |
| Weight/unit | 3 lbs. |
| Shipping Class | A1 |
| # of units/Shipping Units | 1 |
| Weight/shipping unit | 3 lbs. |
| # of shipping units/pallet | 50 |
| Quantity | 500 |
| Unit Type | each |
| Unit Price | $50.00 |
| Extended Price | $25,000.00 |

An inventory may be comprised of one SKU or many SKU line items. The inventory header will summarize the inventory, whereas the inventory detail will list each SKU by row using the required column headings.

The review account pages 46 allow qualified users to administer their account and inventory activity. The tools required to administer offers and account information will reside within this environment. From this location the user will review transaction specific information related to any scenario related to the ability to conduct business on the web site.

The review account area allows company specific information to be modified, updated and/or changed as required by using the master ID. The user can also add additional users with defined access. According to one example embodiment, administrators may set up new users with new passwords. As mentioned above, users can be permitted to buy and/or sell goods using system 28.

In one example embodiment, if the user wishes to review information related to the selling of inventories the following information is displayed on a web page:

Requested Postings:

Accepted for Posting=YES or NO

Comments

Active Postings:

Offers Made=YES or NO

View details of the Offer made

Accept

Reject

Counter

Make Counter Offer.

According to another example embodiment, if the user wishes to review information related to the buying of inventories they will be presented with the following information/options on a web page:

Active Offers Made:

Status of Offer

Accepted

Rejected

Countered

Make Counter Offer.

Accepted Offers:

Status of Transaction

Comments

According to another example embodiment, if the user wishes to review information related to Account History the following is presented:

Account History:

Closed Deals Sold

Closed Deals Purchased

Flexibility to compile reports from history data fields.

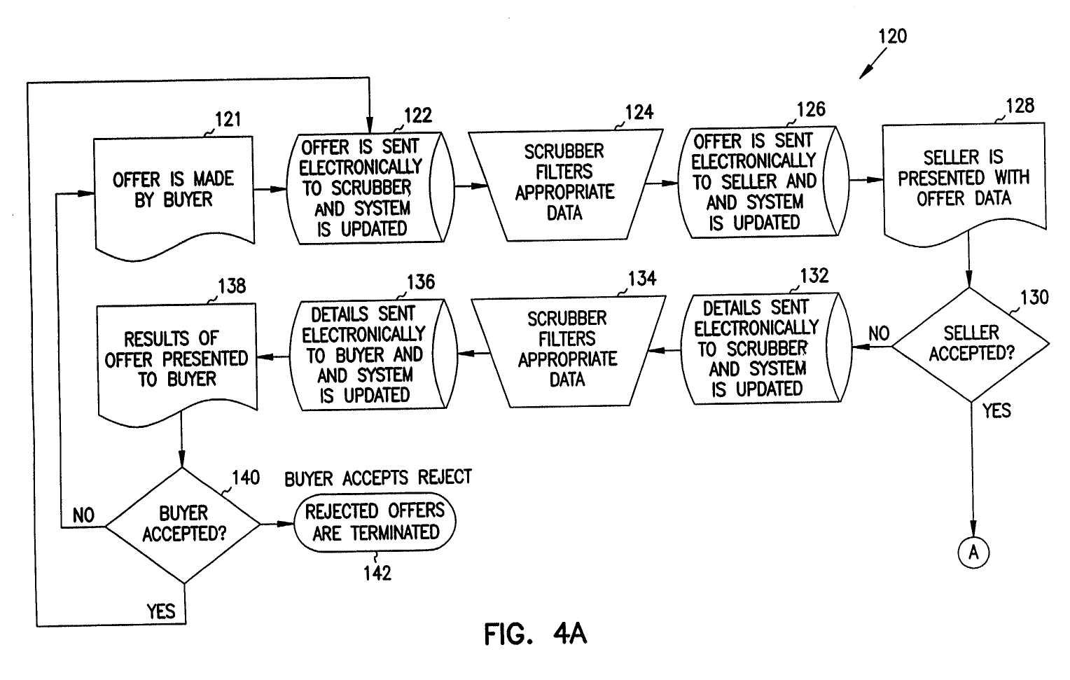

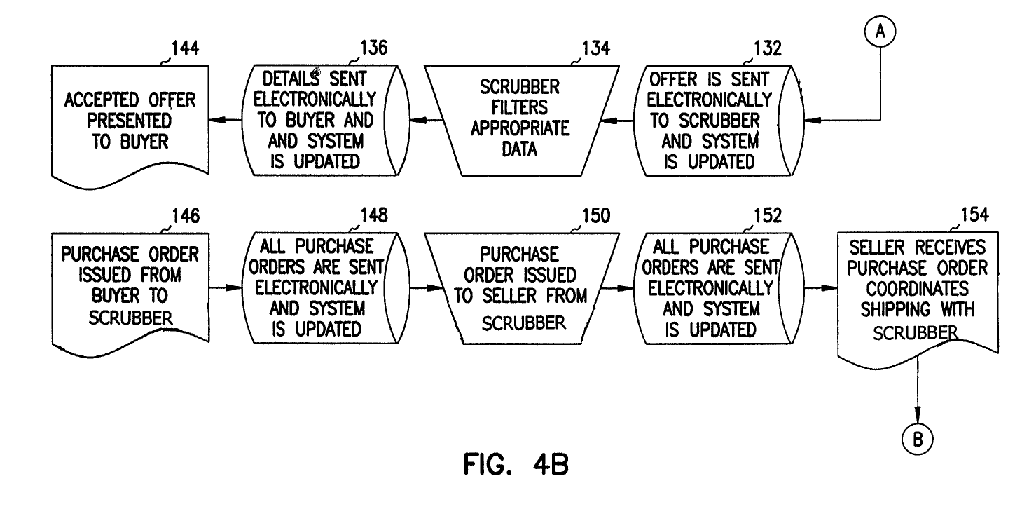

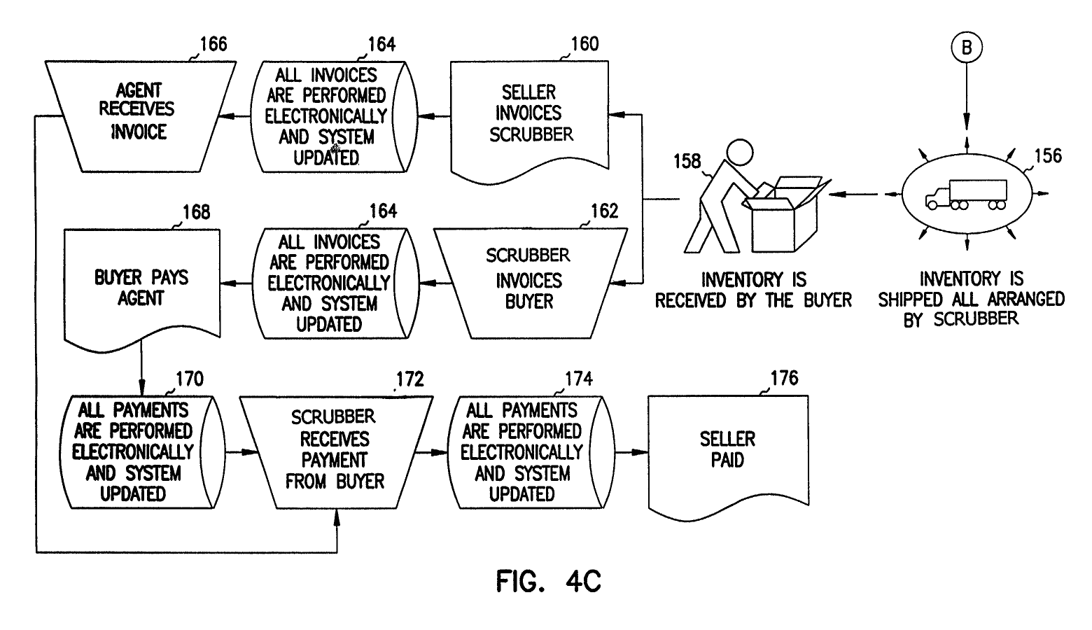

In one example embodiment, the buyer can use the web site 30 to edit quantity and unit price to adjust their offer to purchase. As illustrated further in FIGS. 4a, 4B and 4C, if an offer is submitted and does not match the posted unit price and quantity, the seller will have the option to either accept, reject or counter again. Likewise the response from the seller must be flagged as a counter offer if appropriate. Therefore, much of the same functionality built for the ability to make an offer to purchase will be replicated within the user administration area for the consideration of offers. Otherwise, it is a simple case of rejecting or accepting an offer. In the event the offer is rejected without counter, a buyer can re-enter the system to make a new offer, rather than a counter-offer.

According to one example embodiment, all offer activity must pass through the scrubbing agent's control, through system 28, prior to posting on the web site user administration area and/or notifications to either party. This protects the anonymity of the users. The system 28 and the scrubbing agent, in one example embodiment, will not allow information to pass through that may jeopardize the confidentiality of either party or the elimination of the scrubbing agent's involvement in the transaction.

According to one example embodiment, upon receipt from a qualified buyer of an offer to purchase goods on terms and conditions offered or approved by a qualified seller and notification by e-mail to the qualified buyer of acceptance of its offer to purchase, The scrubbing agent will cause the transaction to be completed as follows: (1) it purchases and accepts title to and delivery of the goods from the qualified seller; (2) it causes the goods to be delivered via common carrier to the qualified buyer; and (3) it invoices and collects the purchase price and the applicable qualified buyer transportation charges from the buyer by wire transfer; provided that the purchase price and transportation charges shall be due and payable by wire transfer immediately upon receipt of an invoice unless a later due date is specified by the invoice. A qualified buyer to whom goods are delivered shall notify the scrubbing agent immediately of any variance between the description of the goods purchased and the goods received.

According to another example embodiment, the scrubbing agent obtains from the seller such warranties relating to goods purchased as are available, and transfers such warranties to the buyer buying the goods. In addition, the scrubbing agent, in one embodiment, represents and warrants to the buyer it transfers good and merchantable title to the goods to the buyer, free and clear of all liens. Accordingly, the buyer has a high degree of assurance in purchases made through the scrubbing agent.

According to yet another example embodiment of the invention, following acceptance of an offer to sell goods by a qualified buyer, and confirmation of receipt of acceptance by the buyer, the qualified seller sells the goods to the scrubbing agent within fifteen (15) business days thereafter unless otherwise agreed between the seller and the scrubbing agent. The sale date is a business day selected by the selling agent unless thirty (30) days credit is extended by the seller. The scrubbing agent pays the purchase price (or an agreed percentage thereof) for the goods when due by wire transfer of immediately available funds or by irrevocable, direct pay letter of credit issued by a national banking association or other financial institution or entity having an acceptable short term credit rating. The seller provides to the scrubbing agent concurrent or prior to such payment, the fees due to the scrubbing agent from the seller with respect to the sale and such documents, instruments and certificates as are customary or reasonable and requested by the scrubbing agent evidencing the transfer of merchantable title to the goods to the scrubbing agent or a person designated by it, free and clear of all liens; applicable warranties; compliance with applicable state and federal laws, including those relating to payment of applicable taxes or exemptions therefrom, bulk sales, security interests and duties and tariffs; and authorization of the sale by the seller and any other person or government entity, agent, trustee, bankruptcy trustee, and representative with power of attorney, having an interest therein or jurisdiction over the goods or their sale. Not more than thirty (30) days after the sale date the scrubbing agent pays any unpaid balance of the purchase price to the seller by wire transfer.

According to one example embodiment of the invention, the scrubbing agent marks up the seller's selling price for each transaction on the web site 30. In the case where sellers use the web site 30, buyer pays, in one example embodiment, the seller's selling price plus the agent markup which is a percentage of the value of the total inventory being offered. This percentage is added to asking price for posting. The percentage may vary depending on the services rendered, as for example shown in the following schedule:

Scrubbing Markup Schedule

| Fees: | Example Percentage |
|---|---|
| Base | 5% |
| Anonymity | 1% |
| Qualification = Quality | 2% |
| Terms (financing) | 2% |
| Guaranteed Payment | 2% |
| Inventory Validation & Consulting | 4% |
| Example Total | 16% |

In this example, the base fee is 5%, with various other services costing additional percentages, such that, for instance, in the example above the total markup is 16% of the total value of the inventory being sold on web site 30.

In the case of buyers, the standard terms may be, for example, net 30 days from receipt of inventory. In the event the buyer pays cash upon receipt, they may receive a discount of −1% of the cost of inventory purchased plus freight. Or, the buyer may pad an additional 1.5% of the cost of inventory purchased plus freight for each 30 days over net 30 from date of receipt of inventory.

According to yet another embodiment, the scrubbing agent may charge a seller a fee based on the quality of the buyer in order that the scrubbing agent guarantee payment of the seller's invoice. In the example schedule set forth below, the buyers may be divided into several levels, A, B and C, each of which has a different risk profile associated with it. In addition, the schedule is broken down by payment to seller in net 30 days, and cash payment.

| | Level A | Level B | Level C |
|---|---|---|---|
| Payment in Net 30 | | | |
| 0 to $250,000 | 10% | 12% | 14% |
| $250k to 500k | 9% | 11% | 13% |
| $500k to $2,000,000 | 8% | 10% | 12% |
| $2.0m to $5.0m | 7% | 9% | 11% |
| $5.0m and over | 6% | 8% | 10% |
| Payment | | | |
| 0 to $250,000 | 12% | 14% | 16% |
| $250K to 500k | 11% | 13% | 15% |
| $500k to $2,000,000 | 10% | 12% | 14% |
| $2.0m to $5.0m | 9% | 11% | 13% |
| $5.0m and over | 8% | 10% | 12% |

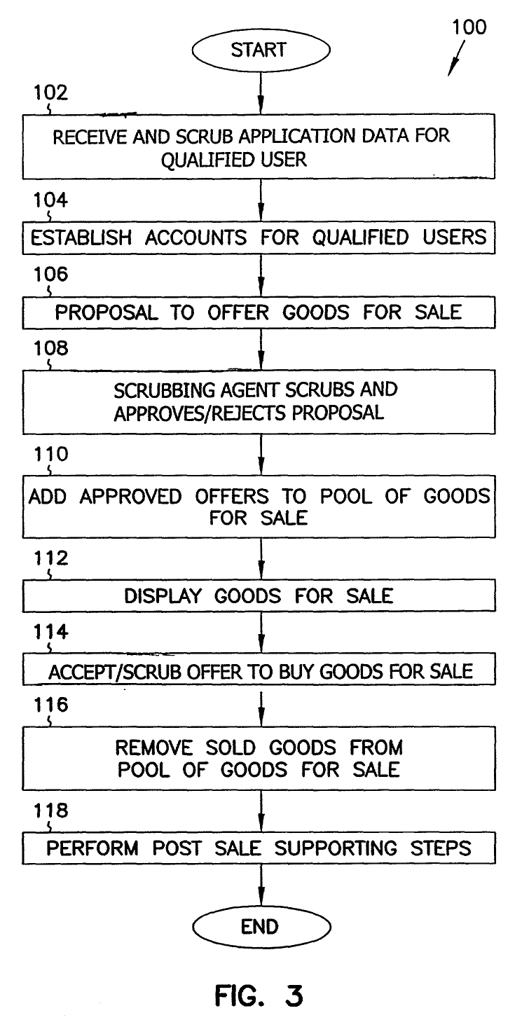

Referring now to FIG. 3, there is illustrated in more detail one embodiment of a process 100 according to the present invention wherein goods are offered for sale on an Internet web site according to the present invention. As illustrated in FIG. 3, process 100 includes, as shown in element 102, generating one or more web pages to receive application data used to qualify an entity to open an account and use the scrubbing agent's web site for the sale of goods. As illustrated in element 104, the agent establishes accounts for use of the web site for qualified buyers and qualified sellers based at least in part on application data received through the web site. According to one embodiment, the account information for a qualified buyer includes data specifying whether the qualified buyer is a wholesaler, retailer, or both, and the geographic territory associated with the qualified buyer. As illustrated by element 106, a qualified seller makes a proposal to offer goods for sale on the web site, wherein the proposal includes data describing the goods for sale and data specifying one or more restrictions on the sale of goods, and, in one embodiment, one or more web pages are generated to receive data from the seller specifying the proposal. As illustrated in element 108, the scrubbing agent approves or rejects a qualified seller's proposal to offer goods for sale on the web site and, in one example embodiment, generates one or more web pages indicating the acceptance or rejection of the proposal. As illustrated by element 110, an approved offer is added to a pool of goods for sale, wherein such pool is represented by a set of data electronic data maintained in connection with the web site. Further, as illustrated in element 112, in response to a request by a qualified buyer to review goods for sale on the web site, and using the set of data, one or more web pages are generated to display information representing pending goods for sale that are available to be purchased by the requesting qualified buyer. According to one example embodiment, goods for sale that are available to the requesting qualified buyer are selected in accordance with the restrictions specified for the sale of the goods by the qualified seller. As illustrated by element 114, one or more web pages are generated to receive data for a qualified buyer's offer to purchase goods for sale or to receive data from a qualified seller accepting, rejecting or counter-offering an offer submitted by a qualified buyer. As shown in element 116, goods associated with accepted offers are removed from the pool of goods for sale and the set of data is updated to reflect the same. Further, one or more post sale processing steps may be performed, such as shipping the goods, invoicing or other sales support steps 118.

According to another example embodiment, to the fullest extent possible, this system and process of the present invention is paperless, wherein all transactions occur electronically. Thus, according to one example embodiment, the system interfaces with EDI systems for those participants working from an EDI platform. Also according to yet another embodiment, all activity generated by the web site is archived for use in reporting required by any internal department and as defined for users.

According to still another example embodiment of the invention, the scrubbing agent provides for anonymous shipping, or a blind bill of lading. In this process, a truck (or other transport such as rail or boat) company picks up product, takes possession not knowing final destination. The product goes to the trucking company's facility for final instructions, where the trucks are given final bill of lading with final destination instructions. All shipping documents reference the entities information as appropriate. For shipping purposes, the web site accommodates zip code to zip code information for product quantity and description, shipping class, weight, and number of trucks required -or- cubic feet required.

Referring now to FIGS. 4A, 4B and 4C there is illustrated a data flow 120 using system 28 for one example embodiment of a transaction according to the present invention. An offer 121 to purchase inventory is made, and is sent electronically 122 to the scrubbing agent and the data stored in the system 28 is updated. The system 28 filters the offer data 124, either automatically or with assistance from the scrubbing agent removing, for example, the identity of the potential buyer making the offer, and the offer is sent electronically to the seller, and the system is updated 126. The offer may be sent via e-mail, for example, and also be available to review online on the web site 30 by the seller when the seller reviews its account status. The seller is thus presented with the offer 128. If 130 the offer is either rejected or accepted, the system 28 databases are updated and information concerning such rejection or acceptance is sent 132 to the scrubbing agent, and system 28 filters the data to remove the identity of the seller 134. Details of the rejection or acceptance are then sent electronically to the buyer and the system 28 is updated 136. If the seller has rejected the offer, the results of the offer are presented to the buyer 138. Such results may include a counter offer. If 140 the buyer in turn rejects the counter offer the offer is terminated 142, and the buyer may again make a new offer 121. If the buyer accepts the counter-offer, the counter is re-presented to the seller through the above-described process beginning at 122.

If an offer is accepted, it is presented to the buyer 144, and a purchase order is issued 146 from buyer to the agent. The purchase order is then sent electronically, for example by e-mail or over the web site 30, and the system 28 is updated 148. A purchase order is then in turn issued to the seller by the agent 150, either over the web site, or by e-mail, or by other means of communication such as mail or fax. Again, this purchase order is sent electronically and the system 28 updated 152. The seller in turn receives the purchase order and coordinates shipping with the agent 154. The inventory is in turn shipped 156, with arrangements made by the agent.

The inventory is then received by the buyer 158. The seller invoices the agent 160, and the agent invoices the buyer 162. The invoicing is performed electronically and the system 28 is updated 164. The agent in turn receives the invoice 166, and the buyer pays the agent 168, using electronic payment, in one example embodiment, and the system 28 is updated 170. The scrubbing agent receives payment from the agent 172, and the scrubbing agent in turn pays the seller 176, again with the payments being performed electronically, and the system updated 174.

In one or more of the embodiments described above, offers are entered into a supporting database on the web site 30, and may be viewed by a buyer or seller reviewing their account information. In one embodiment, the offers are entered directly by a buyer or seller into a form on a web page generated by the site 30, and notices of such pending offers are sent by e-mail to the offeree or applicable party. In another embodiment, offers may be submitted by e-mail to an e-mail inbox of the scrubbing agent or an e-mail inbox maintained as part of the site 30 that the scrubbing agent has access to. The scrubbing agent in turn can enter these offers into the web site data repositories, and notify the other party of the offer. As such, scrubbing data to provide anonymity for example may be done manually by a scrubbing agent personnel, or automatically by electronic filtering of the data by the system 28.

Referring now to FIG. 5 there is illustrated an overview of one embodiment of the Internet system 200 according to the present invention. A scrubbing agent's system 28 is provided, is connected to the Internet 204 and hosts the agent's web site and provides the web pages and other electronic functions as described above. System 28 may be one or more computers, and located in multiple locations. Potential users or prospects' computers 206 are also connected to the Internet 204, and allow potential users to browse the agent's web site using a web browser. In addition, qualified users' computers 208 are also connected to the Internet 204, and allow qualified users to use the scrubbing agent's web site 30 using a web browser.

1. A method for the sale of goods over the Internet, comprising:
a) a scrubbing agent receiving a request to offer goods for sale on an Internet web site, the request specifying the kind of goods, and restrictions on the sale of the goods;
b) the scrubbing agent validating that the goods are as specified in the request;
c) the scrubbing agent offering the goods for sale over the Internet in accordance with any applicable restrictions;
d) the scrubbing agent receiving offers over the Internet to purchase the goods;
e) the scrubbing agent assuring that any sales of the goods will be made in accordance with any restrictions specified for the sale of the goods;
f) the scrubbing agent arranging to ship any sold; and
g) the scrubbing agent invoicing the buyer of goods and remitting payment to the seller of the goods.

2. A method according to claim 1 further including the step of the seller and buyer of the goods remaining anonymous to one another.

3. A method according to claim 1 further including the step of physically inspecting the goods to verify that they are bona fide and in conformance with a proposal from a seller.

4. A method according to claim 1 wherein a restriction on the sale of the goods is the destination for a shipment of the goods.

5. A method according to claim 1 wherein a restriction on the sale of the goods is a type of business that is allowed to purchase the goods.

6. A system for the sale of goods over the Internet, comprising:
a) generating one or more web pages to receive application data used to qualify an entity to open an account and use a web site for the sale of goods;
b) establishing accounts for use of the web site for qualified buyers and qualified sellers based at least on application data, the account information for a qualified buyer including data specifying whether the qualified buyer is a wholesaler, retailer, or both, and the geographic territory associated with the qualified buyer;
c) generating one or more web pages to receive data for a qualified seller's proposal to offer goods for sale on the web site, the proposal including data describing the goods for sale and data specifying one or more restrictions on the sale of goods;
d) approving or rejecting a qualified seller's proposal to offer goods for sale on the web site and generating one or more web pages indicating the acceptance or rejection of the proposal;
e) adding an approved offer to a pool of goods for sale, wherein such pool is represented by a set of data electronic data;
f) in response to a request by a qualified buyer to review goods for sale on the web site, using the set of data to generate one or more web pages to display information representing pending goods for sale that are available to be purchased by the requesting qualified buyer, wherein goods for sale that are available to the requesting qualified buyer are selected in accordance with the restrictions specified for the sale of the goods by the qualified seller;
g) generating one or more web pages to receive data for a qualified buyer's offer to purchase goods for sale or to receive data from a qualified seller accepting, rejecting or counter-offering an offer submitted by a qualified buyer;
h) identify accepted offers and removing the associated goods for sale from the pool of goods for sale and updating the set of data to reflect the same, and performing one or more post sale processing steps; and
i) generating one or more web pages to display data relating to the status of a qualified buyer's or qualified seller's account, including data on any pending offers to sell goods and any pending offers to purchase goods.

7. A system according to claim 6 further wherein the identity of a qualified seller or qualified buyer is not disclosed in connection with the sale of goods over the web site.

8. A system according to claim 6 further including the step of validating a proposal for goods for sale by physically inspecting the goods.

9. A method for the sale of goods over the Internet, comprising:
a) generating one or more web pages to receive application data used to qualify an entity to open an account and use the web site;
b) establishing accounts for use of the web site for qualified buyers and qualified sellers based at least on application data, the account information for a qualified buyer including data specifying whether the qualified buyer is a wholesaler, retailer, or both, and the geographic territory associated with the qualified buyer;
c) generating one or more web pages to receive data for a qualified seller's proposal to offer goods for sale on the web site, the proposal including data describing the goods for sale and data specifying one or more restrictions on the sale of goods;
d) reviewing the qualified seller's proposal to offer goods for sale on the web site including a physical verification of the goods and validating that a proposal is bona fide and approving or rejecting the proposed offer based on the review;
e) adding an approved proposal to a pool of goods for sale on the web site;
f) in response to a request by a qualified buyer to review goods for sale on the web site, generating one or more web pages to display information representing pending goods for sale that are available to be purchased by the requesting qualified buyer, wherein goods for sale that are available to the requesting qualified buyer are selected in accordance with the restrictions specified for the sale of the goods by the qualified seller;
g) generating one or more web pages to receive data for a qualified buyer's offer to purchase goods for sale or to receive data from a qualified seller accepting, rejecting or counter-offering an offer submitted by a qualified buyer;
h) identify accepted offers and removing the associated goods for sale from the pool of goods for sale and updating the set of data to reflect the same, and performing one or more post sale processing steps;
i) generating one or more web pages to display data relating to the status of a qualified buyer's or qualified seller's account, including data on any pending offers to sell goods and any pending offers to purchase goods;
j) the entity operating the web site arranging for shipping of goods associated with accepted offers;
k) the entity operating the web site invoicing a qualified buyer that has purchased goods over the web site; and
l) the entity operating the web site paying the qualified seller that has sold goods over the web site.
